(19) United States
(12) Patent Application Publication
(10) Pub. No.: US 2011/0245373 A1
(43) Pub. Date: Oct. 6, 2011

(54) ACRYLIC THERMAL CONDUCTIVE SHEET AND METHOD FOR PRODUCING THE SAME

(75) Inventor: Masaki Yoda, Kanagawa (JP)

(73) Assignee: 3M INNOVATIVE PROPERTIES COMPANY, Saint Paul, MN (US)

(21) Appl. No.: 13/132,419

(22) PCT Filed: Nov. 17, 2009
(86) PCT No.: PCT/US2009/064680

§ 371 Date: Jun. 2, 2011

(30) Foreign Application Priority Data
Dec. 15, 2008 (JP) 2008-318667

(51) Int. Cl. C08K 3/22

(52) U.S. Cl. 523/220

(57) ABSTRACT

To provide a thermal conductive sheet having improved thermal conductivity while maintaining flexibility and flame retardancy, and a method for producing the same. The above sheet can be obtained from hardened material comprising: a binder component (A) containing at least one alkyl(meth)acrylate monomer having an alkyl group of 12 to 18 carbon atoms and/or a partial polymer thereof; aluminum hydroxide particles (B) having an average particle diameter of 0.3 m or more and less than 4.0 m which are obtained by a crystallization method and are not subjected to a pulverization treatment; aluminum hydroxide particles (C) having an average particle diameter of 4.0 m or more and 15.0 m or less which are obtained by a crystallization method and are not subjected to a pulverization treatment, and also satisfy the relation: average particle diameter of the particles (C)/average particle diameter of the particles (B)=3 to 15; and a reaction initiator (D); wherein the content of the component (A) is 100 parts by mass, the content of the component (B) is from 50 to 400 parts by mass, the content of the component (C) is from 50 to 1,000 parts by mass, and the content of the component (D) is from 0.01 to 5 parts by mass.

### TECHNICAL FIELD

The present disclosure relates to a flame retardant thermal conductive sheet comprising a thermal conductive filler and a binder, and a method for producing the same.

### BACKGROUND

As is well known, a thermal conductive sheet efficiently causes cooling or releasing of heat generated in electronic equipment and is therefore widely used so as to attach a thermal sink (coolant) or a cooling wheel to electronic equipment. With recent progress of miniaturization and higher density integration of electronic equipment, there are increasing demands for a thermal conductive sheet which has high thermal conductivity and is also flexible and exerts less load on CPU chips during use. At the same time, there are increasing demands for a thermal conductive sheet using a non-silicon-based compound (containing a siloxane) which is free from any concern for contact fault as a result of paying attention to the fact that a silicon-based compound causes contact fault in electronic equipment.

Japanese Unexamined Patent Publication (Kokai) No. 2005-226007 (WO2005-082999) describes a thermal conductive sheet made of a composition comprising (A) a (meth)acryl polymer, (B) a halogen-free flame retardant selected from the group consisting of an organophosphorus compound, a triazine skeleton-containing compound, an expanded graphite and polyphenylene ether and (C) a composition containing a hydrated metal compound, wherein the hydrated metal compound accounts for 40 to 90% by volume of the total volume of the composition.

Japanese Unexamined Patent Publication (Kokai) No. 2008-111053 (WO2008-055014) describes a thermal conductive sheet comprising (A) a photopolymerizable component composed of a (meth)acrylic monomer or a partial polymer thereof, (B) a thermal conductive filler, (C) a photoreaction initiator for initiating polymerization of the photopolymer component (A), and (D) a light absorber which absorbs a predetermined wavelength band from electromagnetic wave used to perform polymerization of the photopolymerization initiation moiety (A) thereby removing the predetermined wavelength band.

Japanese Unexamined Patent Publication (Kokai) No. 10-316953 (WO2008-055014) describes a base material and an adhesive sheet comprising a releasable thermal conductive pressure-sensitive adhesive coated on one or both surfaces of the base, the releasable thermal conductive pressure-sensitive adhesive comprising a) 100 parts by mass of a polymer of a monomer composed of 70 to 100% by mass of an alkyl(meth)acrylate having an alkyl group of 2 to 14 carbon atoms on average and 30 to 0% by mass of a monoethylenic monomer which is copolymerizable with the alkyl (meth)acrylate, b) 20 to 400 parts by mass of a plasticizer having a boiling point of 150° C. or higher, and c) 10 to 1,000 parts by mass of a thermal conductive filler.

Japanese Unexamined Patent Publication (Kokai) No. 2006-213845 describes a thermal conductive pressure-sensitive adhesive sheet-like molded foam (F) in which a foam cell has an average diameter of 50 to 550 μm, which is obtained by forming a thermal conductive pressure-sensitive adhesive composition (E) comprising 100 parts by mass of a (meth)acrylate ester polymer (A1), 20 to 55 parts by mass of a (meth)acrylate ester monomer mixture (A2m), 50 to 500 parts by mass of a thermal conductive inorganic compound (B), 0.1 to 5 parts by mass of an organic peroxide thermopolymerization initiator (C2) and 0.01 to 0.8 parts by mass of a pyrolytic organic blowing agent (D) into a sheet and heating the sheet, thereby performing formation of the thermal conductive pressure-sensitive adhesive composition (E) into a sheet, polymerization of the (meth)acrylate ester monomer mixture (A2m), and thermal decomposition of the pyrolytic organic blowing agent (D).

Japanese Unexamined Patent Publication (Kokai) No. 5-58623 describes a method relates to aluminum hydroxide in which the average secondary particle diameter on a mass basis is from 6 to 16 μm, the content of particles of 30 μm or more is 10% by mass or less and the content of particles of 4 μm or less is 20% by mass, the BET specific surface area is 1 m²/g or less, and the aggregation index is 1.6 or less, and describes, as a method for producing the same, a method of adding 5 g/l or more of a ground gibbsite seed having an MF value of 10 or more and an average particle diameter of 3 to 10 μm to a sodium aluminate solution having a supersaturation degree of 1.1 to 1.8 thereby precipitating aluminum hydroxide.

### SUMMARY

A thermal conductive sheet having low or no odor and also having flexibility and a method for producing the same have been required. Also, it has been required that thickening, which can cause deterioration of workability of a mixture, does not arise during formation of a sheet.

On aspect of the present disclosure is an acrylic thermal conductive sheet made of hardened material comprising: a binder component (A) containing at least one alkyl (meth)acrylate monomer having an alkyl group of 12 to 18 carbon atoms and/or a partial polymer thereof; aluminum hydroxide particles (B) having an average particle diameter of about 0.3 μm or more and less than 4.0 μm which are obtained by a crystallization method and are not subjected to a pulverization treatment; aluminum hydroxide particles (C) having an average particle diameter of 4.0 μm or more and about 15.0 μm or less which are obtained by a crystallization method and are not subjected to a pulverization treatment, and also satisfy the relation: average particle diameter of the particles (C)/average particle diameter of the particles (B)=about 3 to about 15; and a reaction initiator (D); wherein the content of the component (A) is 100 parts by mass, the content of the component (B) is from about 50 to about 400 parts by mass, the content of the component (C) is from about 50 to about 1,000 parts by mass, and the content of the component (D) is from about 0.01 to about 5 parts by mass.

Another aspect of the present disclosure is a method for producing an acrylic thermal conductive sheet, which comprises the steps of: mixing a binder component (A) containing at least one alkyl(meth)acrylate monomer having an alkyl group of 12 to 18 carbon atoms and/or a partial polymer thereof, aluminum hydroxide particles (B) having an average particle diameter of about 0.3 μm or more and less than 4.0 μm which are obtained by a crystallization method and are not subjected to a pulverization treatment, aluminum hydroxide particles (C) having an average particle diameter of 4.0 μm or more and about 15.0 μm or less which are obtained by a crystallization method and are not subjected to a pulverization treatment, and also satisfy the relation: average particle diameter of the particles (C)/average particle diameter of the particles (B)=about 3 to about 15, and a reaction initiator (D) in a ratio of 100 parts by mass of the component (A); about 50 to about 400 parts by mass of the component (B); about 50 to about 1,000 parts by mass of the component (C); about 0.01 to about 5 parts by mass of the component (D); and forming the mixture obtained by the above mixing step into a sheet and hardening the sheet.

In the present specification, the expression “(meth)acrylate” means “acrylate” or “methacrylate”.

According to the present disclosure, it becomes possible to provide a high thermal conductive sheet, which has low or no odor, and also has sufficient flexibility and flame retardancy of a grade of UL94 V-0, while maintaining satisfactory workability.

### BRIEF DESCRIPTION OF THE DRAWINGS

FIG. 1 is an electron microscopy image (magnification: ×1,000) of aluminum hydroxide particles (B) (Nippon Light Metal Co., Ltd. product number: BF083) which can be used in one aspect of the present disclosure.

### DETAILED DESCRIPTION

The present disclosure will now be described in detail by way of some embodiments.

The thermal conductive sheet of the present disclosure is obtained by a crystallization method and also contains aluminum hydroxide particles (hereinafter referred to as a “thermal conductive filler”) which are not subjected to a pulverization treatment, and a binder.

Item (1): The thermal conductive sheet as one aspect of the present disclosure is a thermal conductive sheet comprising: a binder component (A) containing at least one alkyl (meth)acrylate monomer having an alkyl group of 12 to 18 carbon atoms and/or a partial polymer thereof; aluminum hydroxide particles (B) having an average particle diameter of about 0.3 μm or more and less than 4.0 μm which are obtained by a crystallization method and are not subjected to a pulverization treatment; aluminum hydroxide particles (C) having an average particle diameter of 4.0 μm or more and about 15.0 μm or less which are obtained by a crystallization method and are not subjected to a pulverization treatment, and also satisfy the relation: average particle diameter of the particles (C)/average particle diameter of the particles (B)=about 3 to about 15; and a reaction initiator (D); wherein the content of the component (A) is 100 parts by mass, the content of the component (B) is from about 50 to about 400 parts by mass, the content of the component (C) is from about 50 to about 1,000 parts by mass, and the content of the component (D) is from about 0.01 to about 5 parts by mass.

As used herein, the crystallization method means a method of precipitating aluminum hydroxide particles by placing a seed crystal in a supersaturated solution of an extract of a Bayer process. (Please see The Chemical Dictionary (of Japan), published by Kyoritu syuppann, Ltd, 1^{st} Edition, volume 7, page 33).

“Pulverization treatment” means the treatment including “milling”, “comminution”, “pulverization”, “size reduction”, “smash”, and “trituration”, etc., which is aimed for reducing the size of the particles by way of the mechanical stress.

Aluminum hydroxide particles are used, since they are excellent in filling properties, economical efficiency and flame retardancy.

Since aluminum oxide particles obtained by the crystallization method are not subjected to a pulverization treatment of particles, each of particles doses not have a milled surface such as a cleavage surface and can maintain a nearly spherical shape.

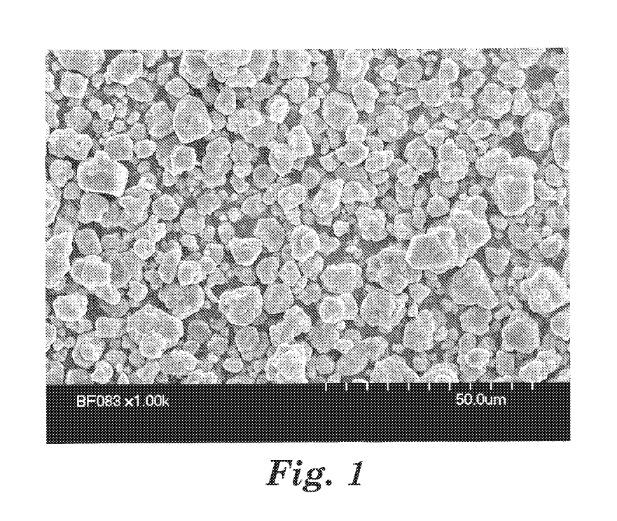

An electron micrograph of aluminum hydroxide particles, which are obtained by the crystallization method used in one aspect of the present disclosure and are not subjected to a pulverization treatment, is shown in FIG. 1.

In one aspect, it is considered that use of particles having a nearly spherical shape enables suppression of an increase in viscosity even if the filling ratio of particles in the binder is increased, and thus workability is improved. Furthermore, it is considered that use of particles having a nearly spherical shape enables suppression of an increase in hardness of the sheet after hardening.

Precipitation of crystals from the solution leads to a narrow particle size distribution as described hereinafter. Utilizing this narrow distribution, the filling ratio is improved by filling a space between the particles (C) with an appropriate amount of the aluminum hydroxide particles (B) in one aspect of the present disclosure.

Any particle diameter in the present specification means a volume average particle diameter measured by a Microtrac meter.

In one aspect of the present disclosure, the above particles having a nearly spherical shape are used, and particles and binders are used in a ratio and parts by mass described in Item (1).

(B) Particles having a particle diameter of (about 0.3 μm or more and less than 4.0 μm) are selected so as to improve flame retardancy and to suppress excess sedimentation of particles in a coating solution during production since a large cohesive force between particles is easily obtained. (C) Particles having a particle diameter of (4.0 μm or more and about 15.0 μm or less) are selected so as to ensure a high filling ratio and sufficient flexibility of the sheet in accordance with a relation with the particles (B).

Average particle diameter of the particles (C)/average particle diameter of the particles (B) is within a range from about 3 to about 15, preferably from about 5 to about 10, and more preferably from about 6 to about 8. Within the above range, ease of production of the sheet is ensured and also a sheet having satisfactory flame retardancy and flexibility can be produced.

Thus, provision of a satisfactory sheet having an increased filling ratio of about 70% by volume based on the entire hardened material, and also having high thermal conductivity while maintaining advantages such as satisfactory workability and flexibility can be achieved.

Item (2): In another aspect, the thermal conductive sheet is an acrylic thermal conductive sheet which is made of hardened material further comprising aluminum hydroxide particles (E) having an average particle diameter of about 40 to about 90 μm which are obtained by a crystallization method and are not subjected to a pulverization treatment, wherein the content of the component (A) is about 100 parts by mass, the content of the component (B) is from about 50 to about 400 parts by mass, the content of the component (C) is from about 50 to about 1,000 parts by mass, the content of the component (D) is from about 0.01 to about 5 parts by mass, and the content of the component (E) is from about 0.01 to about 700 parts by mass.

Thus, provision of a satisfactory sheet having an increased filling ratio of about 75% by volume based on the entire hardened material, and also having high thermal conductivity while maintaining advantages such as satisfactory workability and flexibility can be achieved.

In this case, use of the particles (E) enables easier adjustment of physical properties such as thermal conductivity.

Item (3): As described above, in one aspect of the present disclosure, it becomes possible to adjust the total filling ratio of the component (B), component (C) and component (E) to about 60 to about 80% by volume of the acrylic thermal conductive sheet based on the entire hardened material while maintaining advantages such as workability, flexibility and high thermal conductivity.

Aluminum hydroxide particles, which are obtained by a crystallization method and are not subjected to a pulverization treatment and, used in one aspect of the present disclosure have a nearly spherical shape and have a narrow particle size distribution. These aluminum hydroxide particles are commercially available from Nippon Light Metal Co., Ltd. as products (for example, model number: BF013, BF083, B53, etc.).

Although it is not usually required when using these particles because of the narrow particle size distribution, it is possible to mix particles in a desired ratio, each having a particle diameter within a desired range, which are obtained by optionally classifying the above particles using conventional techniques, for example, dry classification such as inertial classification or centrifugal classification, wet classification such as sedimentation classification or mechanical classification, screening classification, etc.

If necessary, each surface of the thermal conductive filler particles may be subjected to treatments such as a silane treatment, titanate treatment and polymer treatment. Strength, flexibility, water resistance and insulating properties can also be imparted to the thermal conductive sheet by these surface treatments. In one aspect, the average particle diameter and parts by mass of aluminum hydroxide particles as the thermal conductive filler satisfy the relations described in the above Item (1) and Item (2). If necessary, it is possible to add particles each having an average particle diameter of about 0.01 μm or more, about 0.1 μm or more, about 0.3 μm or more and about 0.5 μm or more, and about 500 μm or less, about 90 μm or less, about 15.0 μm or less and about 4.0 μm or less, so as to adjust physical properties, etc.

If necessary, to the thermal conductive sheet, another kind of thermal conductive filler, for example, metal oxides such as ceramics and alumina, metal hydroxides such as magnesium hydroxide, and metals may be added, or a mixture of two or more kinds of them may be added.

The binder component used in one aspect of the present disclosure usually contains an alkyl(meth)acrylate monomer having an alkyl group of 12 to 18 carbon atoms and/or a partial polymer thereof. As long as the hardened sheet can have low or no odor, the binder component can contain an alkyl(meth)acrylate monomer having an alkyl group of less than 12 carbon atoms and/or a partial polymer thereof according to necessity of an improvement in operability. As long as handlability does not deteriorate, for example, solidification of the binder component does not occur, the binder component can contain an alkyl(meth)acrylate monomer having an alkyl group of more than 18 carbon atoms and/or a partial polymer thereof.

(The acrylic thermal conductive sheet, which does not generate a siloxane gas, is used, for example, so as to efficiently release heat generated in electronic equipment.)

In one aspect of the present disclosure, since particles having a nearly spherical shape are used as described above, viscosity scarcely increases and satisfactory workability can be ensured even when an alkyl(meth)acrylate having an alkyl group of 12 or more carbon atoms used in one aspect of the present disclosure is used. As a result, it becomes possible to achieve low or no odor which has never been achieved in the prior art in which an unreacted acrylic monomer remains when an alkyl acrylate having 6 to 8 carbon atoms such as 2-ethylhexyl acrylate or n-butyl acrylate is used. Furthermore, when the binder used in one aspect of the present disclosure has an alkyl group of 18 or less carbon atoms, the acrylate is in a liquid state at room temperature without being solidified, and thus it is preferred.

In the monomer of the alkyl(meth)acrylate and/or a partial polymer thereof used in one aspect of the present disclosure, the alkyl(meth)acrylate is an alkyl(meth)acrylate having an alkyl group of 12 to 18 carbon atoms, and specific examples thereof include dodeca (meth)acrylate, trideca (meth)acrylate, tetradeca (meth)acrylate, pentadeca (meth)acrylate, hexadeca (meth)acrylate, heptadeca (meth)acrylate and octadeca (meth)acrylate, etc. These acrylates may be straight-chain or branched acrylates. The alkyl(meth)acrylate monomer and/or partial polymer thereof may contain a heteroatom such as N or S, an anhydride, a cyclic compound and an aromatic compound in the skeleton thereof so as to improve the cohesive force and to adjust the glass transition point.

It is considered that, in one aspect of the present disclosure, by adjusting the content of the component (B) within a range from about 50 to about 400 parts by mass and the content of the component (C) within a range from about 50 to about 1,000 parts by mass or the content of the component (B) within a range from about 50 to about 400 parts by mass, the content of component (C) within a range from about 50 to about 1,000 parts by mass and the content of the component (E) within a range from about 0.01 to about 700 parts by mass based on about 100 parts by mass of the component (A), the binder component moderately exists between the particles, and thus it becomes possible to balance high thermal conductivity with flexibility in a thermal conductive sheet in which hardness conventionally increases when thermal conductivity increases.

The binder component (A) containing an alkyl(meth)acrylate monomer and/or a partial polymer thereof is polymerized and hardened by adding a reaction initiator. The reaction can be performed by various methods and examples of the method include thermopolymerization, ultraviolet ray polymerization, electron beam polymerization, γ-ray irradiation polymerization and ion beam polymerization.

As a thermopolymerization initiator, for example, organic peroxide free radical initiators such as diacyl peroxides, peroxy ketals, ketone peroxides, hydro peroxides, dialkyl peroxides, peroxy esters and peroxy dicarbonates can be used. Specific examples thereof include lauroyl peroxide, benzoyl peroxide, cyclohexanone peroxide, 1,1-bis(t-butylperoxy) 3,3,5-trimethylcyclohexane and t-butylhydro peroxide. Alternately, a combination of a persulfate/bisulfite may be used.

Examples of the photoinitiator include benzoin ethers such as benzoin ethyl ether and benzoin isopropyl ether; anisoin ethylether and anisoin isopropyl ether; Michler's ketone (4,4′-tetramethyldiaminobenzophenone); and substituted acetophenones such as 2,2-dimethoxy-2-phenylacetophenone (for example, KB-1 available from Sartomer, Irgacure™ 651, 819 available from Ciba Japan Limited) and 2,2-diethoxyacetophenone. The photoinitiator further includes substituted α-ketols such as 2-methyl-2-hydroxypropiophenone; aromatic sulfonyl chlorides such as 2-naphthalenesulfonyl chloride; and photoactive oxime-based compounds such as 1-phenone-1,1-propanedione-2-(o-ethoxycarbonyl)oxime. Alternately, any combination of the above-mentioned thermopolymerization initiator or photopolymerization initiator, etc., can be used.

The amount of the reaction initiator (D) component is not particularly limited as long as it can sufficiently initiate the reaction and can be used in an amount which does not exert an adverse influence on the reaction and a thermal conductive sheet to be formed.

When the reaction initiator component is used in the amount of about 0.01 parts by mass or more, about 0.1 parts by mass or more, about 5 parts by mass or less, or about 1.5 parts by mass or less, based on 100 parts by mass of the binder component (A) containing an alkyl(meth)acrylate monomer and/or a partial polymer thereof, the reaction can be sufficiently initiated and the polymer obtained after polymerization has a sufficient cohesive force and thus a sheet having satisfactory handlability can be obtained, which is preferable.

To the composition constituting the thermal conductive sheet of one aspect of the present disclosure, optional crosslinking agents, plasticizers, chain transfer agents, tackifiers, light absorbers, antioxidants, flame retardant aids, sedimentation inhibitors, thickeners, thixotropic agents, surfactants, surface treating agents, defoamers, colorants, chain transfer agents and crosslinking agents can be added so as to obtain preferable physical properties.

Any particle diameter in the present specification is a particle diameter measured by a Microtrac meter as described hereinafter.

Item (4): Another aspect of the present disclosure is a method for producing an acrylic thermal conductive sheet, which comprises the steps of: mixing a binder component (A) containing at least one alkyl(meth)acrylate monomer having an alkyl group of 12 to 18 carbon atoms and/or a partial polymer thereof, aluminum hydroxide particles (B) having an average particle diameter of about 0.3 μm or more and less than 4.0 μm which are obtained by a crystallization method and are not subjected to a pulverization treatment, aluminum hydroxide particles (C) having an average particle diameter of 4.0 μm or more and about 15.0 μm or less which are obtained by a crystallization method and are not subjected to a pulverization treatment, and also satisfy the relation: average particle diameter of the particles (C)/average particle diameter of the particles (B)=about 3 to about 15, and a reaction initiator (D) in a ratio of 100 parts by mass of the component (A); about 50 to about 400 parts by mass of the component (B); about 50 to about 1,000 parts by mass of the component (C); about 0.01 to about 5 parts by mass of the component (D); and forming the mixture obtained by the above mixing step into a sheet and hardening the sheet.

The thermal conductive sheet can be produced by using various techniques within the scope of the present disclosure. In general, the objective sheet forming composition is prepared by adding the above-mentioned components at a time or sequentially adding them and well kneading the resulting mixture. In order to improve operability, etc., a partial polymer can be optionally prepared by previously polymerizing a portion of at least one alkyl(meth)acrylate monomer using the reaction initiator (D). This partial polymer can be a partial polymer with or without further polymerization reactivity. In kneading of the mixture, a commercially available kneader such as planetary mixer can be used. After kneading, the kneaded mixture is optionally degassed and the resulting mixture is formed into a sheet. In formation of the sheet, for example, calendar molding and press molding can be used. These molding methods can be carried out using a common technique. For example, according to the calendar molding method, a sheet forming mixture is coated in a predetermined thickness on a support, for example, a liner, which has release properties to the mixture or which has been subjected to a release treatment, to form a coat of the unhardened mixture. Although a polyethylene terephthalate (PET) film or another plastic film can be advantageously used, a metal foil may also be used. In the case of irradiating with electromagnetic waves so as to photopolymerize in a latter step, it is advantageous to use a support which has properties capable of transmitting electromagnetic wave, namely, transparency to electromagnetic waves. Examples of coating means include die coating and roller coating, etc. The thickness of the coat of the mixture can optionally vary according to the thickness of the desired thermal conductive sheet.

In one aspect of the present disclosure, a high thermal conductive sheet, which has satisfactory workability of the mixture and also has flexibility while increasing a filling ratio, can be obtained by preparing, as shown in the above Item (4), the binder component (A) containing the alkyl(meth)acrylate monomer and/or partial polymer thereof, the aluminum hydroxide particles (B) and (C) which satisfy the relation: average particle diameter of the particles (C)/average particle diameter of the particles (B)=about 3 to about 15, and the reaction initiator (D) in each predetermined parts by mass, as shown in the above Item (4), mixing them using a mixer, degassing the mixture, coating the mixture on a sheet, and hardening the mixture.

In another aspect of the present disclosure, a high thermal conductive sheet, which has satisfactory workability of the mixture and also has flexibility while increasing the filling ratio, can be obtained by providing aluminum hydroxide particles (E) in addition to the above Item (4) and performing the same steps using the component (A), the component (B), the component (C), the component (D) and the component (E) each in the above-mentioned parts by mass. Furthermore, use of the particles (E) makes it easier to adjust physical properties such as thermal conductivity.

After formation of the coat of the mixture, the coat is haredened by thermopolymerization or photopolymerization to from a thermal conductive sheet. When thermopolymerization is used, a precursor composition can be polymerized by heating to about 80° C. to about 170° C. In the case of photopolymerization, ultraviolet ray polymerization using a mercury lamp, etc., can be used. The irradiation intensity and irradiation time of electromagnetic waves can vary according to factors such as the kind of the photopolymerizable component and the thickness of the coat. In the case of ultraviolet ray, the irradiation intensity can be usually within a range from about 0.1 to about 100 mW/cm², and is preferably from about 0.3 to about 10 mW/cm². The irradiation time of ultraviolet ray is usually from about 5 to about 30 minutes. The photopolymerization step can be usually performed at a temperature of about 20 to about 50° C.

As a result of the polymerization, the objective thermal conductive sheet is obtained. The thickness of the thermal conductive sheet can vary within a wide range and is optionally controlled to a proper thickness. For example, the thickness of the thermal conductive sheet is generally about 0.1 mm or more and about 10.0 mm or less.

The thermal conductive sheet of one aspect of the present disclosure is usually used in the form of a single layer, or optionally used in the form of two- or more multi-layers.

The filling ratio of the component (B), the component (C) and the component (E) of the thermal conductive sheet thus formed is from about 60 to about 80% by volume of the acrylic thermal conductive sheet based on the entire hardened material.

The thermal conductive sheet of one aspect of the present disclosure can be advantageously used in various technical fields including the electronics field. The thermal conductive sheet can be advantageously used when a thermal sink and a cooling wheel are attached to electronic equipment, for example, semiconductor packages, power transistors, semiconductor chips (IC chips, LSI chips, VLSI chips, etc.) and central processing units (CPU). As a matter of course, there is no limitation on the form and size of the thermal sink and cooling wheel used herein.

### EXAMPLES

### Measurement of Particle Diameter

The average volume particle diameter was measured using a laser diffraction particle size analyzer (for example, Microtrac HRA particle size analyzer manufactured by NIKKISO CO., LTD.) in accordance with JIS Z 8825-1:2001 (Particle Size Analysis—Laser Diffraction Method—Part One: Measurement Principle). Measuring conditions are as follows:

Solvent: Aqueous solution comprising 99 parts of pure water and 1 part of a nonionic surfactant (alkylene oxide adduct of higher alcohol, Naloacty HN-100, manufactured by Sanyo Chemical Industries, Ltd.)

Concentration of sample: 1% by mass

Solvent refractive index: 1.33

Particle refractive index: 1.57

Measuring temperature: 25° C.

Particles transmission: transmittable

Shape of particles: non-spherical shape

Particle size distribution of particles used in one example of the present disclosure was measured as follows: σ denotes standard deviation and it covers 68.27% of the entire particle size distribution at an average volume particle diameter±σ.

Product number: BF013, average volume particle diameter: 1.4 μm, average volume particle diameter−σ: 1.4 μm, average volume particle diameter+σ: 1.5 μm

Product number: BF083, average volume particle diameter: 11.8 μm, average volume particle diameter−σ: 7.8 μm, average volume particle diameter+σ: 13.1 μm (Any product number denotes a product number of Nippon Light Metal Co., Ltd.)

The above results reveal that the particles have a narrow particle size distribution.

### Measurement of Thermal Conductivity

With respect to a 1 mm thick thermal conductive sheet (thickness: 1.0×10⁻³ m), a slice measuring 0.01 m×0.01 m (measuring area: 1.0×10⁻⁴ m²) was interposed between a heat generation plate and a cooling plate, and the temperature difference between the heat generation plate and the cooling plate (measuring apparatus: mobile temperature recorder, name of manufacturer: KEYENCE CORPORATION, model number: NR1000) was measured while maintaining at an electric power of 4.8 W under a fixed load of 7.6×10⁴ N/m² for 5 minutes. Thermal resistance R_{1.0t} was calculated by the following equation:

R_{1.0t}(k·m²/W)=temperature difference (K)×measuring area (m²)/electric power (W)

Furthermore, a sample was produced by laminating two sheets described above and thermal resistance R_{2.0t} (K·m²/W) of a sample having a thickness of 2.0×10⁻³ m was measured in the same manner. Using R_{1.0t} and R_{2.0t} thus measured, thermal conductivity λ (W/m·K) was measured using the following equation:

λ(W/m·K)=L(m)/((R_{2.0t} (K·m²/W)−R_{1.0t}(K·m²/W))

### Measurement of Hardness of Thermal Conductive Sheet

Flexibility of the thermal conductive sheet is preferably expressed by “Asker C” hardness. Maximum Asker C hardness is 100 and minimum is about 5 in accordance with a relation with handlability. Asker C hardness is preferably about 5 to about 25, and more preferably from about 8 to 18.

A measuring sample was made by laminating 10 acrylic thermal conductive sheets (thickness: 1 mm) and hardness of the sample was measured under a load of 1 kg using an Asker C hardness tester (manufactured by KOBUNSHI KEIKI CO., LTD.). In this case, 10 seconds after contact of the hardness tester with the sample, the value of gradation was taken as a measured value. The smaller the Asker C hardness, the more flexible the sample is.

### Flame Retardancy Test

Flame retardancy test is performed in accordance with UL-94. A sample measuring 13 mm×125 mm of a thermal conductive sheet was vertically disposed and one end thereof was held by a holding clamp. At this time, cotton was disposed at a position which is 30 cm under the sample. Next, the sample was caused to contact the flame of a burner for 10 seconds. After first flame contact followed by extinction of the flame, second flame contact was performed for 10 seconds. This flame contact was performed for 5 samples with flame contact being performed twice for each sample. With respect to each sample, the following recording was performed:
Flame maintenance time after first contact with a burner flame.
Flame maintenance time after second contact with the burner flame.
Glowing combustion time after second contact with the burner flame.
Whether or not flame dripping ignites the cotton disposed under the sample.
Whether or not the sample is combusted to the holding clamp.

Criteria of passing of sample with a grade of “V-0” are as follows:
The total flame maintenance time for each sample is 10 seconds or less.
The total flame maintenance time for the 5 samples is 50 seconds or less.
The flame maintenance time and the glowing combustion time for each sample after the second contact with the burner flame are 30 seconds or less.
Flame dripping from the sample shall not the ignite cotton.
All samples shall not cause glowing combustion or flame maintenance combustion to the holding clamp.

### Odor Test

According to a comparison of odor between a thermal conductive sheet using conventionally used 2-ethylhexyl acrylate as a binder component and other thermal conductive sheets, odor was evaluated by optionally selected 10 panelists. Evaluations and evaluation criteria are as follows:

“A”: 8 panelists among 10 panelists rated as lower odor than that of a control sample.

“B”: 4 to 7 panelists among 10 panelists rated as lower odor than that of a control sample.

“C”: Results other than “A” or “B”.

### Examples 1 to 5

According to the formulations shown in Table 2, components were simultaneously placed in a planetary mixer and then kneaded under reduced pressure (66.7×10³ Pa) for 15 minutes to obtain mixtures. Each of the mixtures was interposed between two polyethylene terephthalate (PET) liners (name of manufacturer: FUJIMORI KOGYO CO., LTD., product number: Filmbyna 50E-0011 BD, thickness: 50 μm) treated with a silicone mold release agent, followed by calendar molding to form a sheet. While holding the mixture between the two PET liners, both surfaces of the sheets were simultaneously irradiated with ultraviolet rays at an irradiation intensity of 0.3 mW/cm² for 6 minutes and then irradiated at an irradiation intensity of 6.5 mW/cm² for 6 minutes, thereby hardening the sheets to obtain 1.0 mm thick acrylic thermal conductive sheets.

TABLE 1
Formulation of acrylic thermal conductive sheet and evaluation results

| | | | | |
|---|---|---|---|---|
| Example 1 | Example 2 | Example 3 | Example 4 | Example 5 |

Components (number of carbon atoms of alkyl group) parts by mass

| | | | | | | |
|---|---|---|---|---|---|---|
| Binder | 2-ethylhexyl acrylate (C8) | | | | | |
| composition | Lauryl acrylate (C12) | 100.00 | 30.00 | 100.00 | | 80.00 |
| | Partial polymer of lauryl acrylate (12) | | | | | 20.00 |
| | Isostearyl acrylate (C18) | | 70.00 | | 100.00 | |
| | Stearyl acrylate | | | 43.00 | | |
| | 1,6-hexanediol diacrylate (crosslinking agent) | 0.18 | 0.14 | 0.31 | 0.20 | 0.24 |
| | Diisononyl adipate (plasticizer) | 60.00 | 60.00 | 86.00 | 60.00 | 60.00 |
| | Irgacure ™ 819 (photoinitiator) | 0.30 | 0.30 | 0.43 | 0.30 | 0.30 |
| | Titacoat ™ S-151 (titanate coupling agent) | 4.00 | 4.00 | 5.70 | 4.00 | 4.00 |
| Filler | Aluminum hydroxide A (average particle | 150 | 220 | 214 | 220 | 220 |
| | diameter: 1.3 μm, non-milled) | | | | | |
| | Aluminum hydroxide A (average particle | 550 | 580 | 714 | 660 | 380 |
| | diameter: 8 μm, non-milled) | | | | | |
| | Aluminum hydroxide C (average particle | 200 | 300 | | | |
| | diameter: 50 μm, non-milled) | | | | | |
| | Aluminum hydroxide D (average particle | | | | | |
| | diameter: 2 μm, milled) | | | | | |
| | Aluminum hydroxide E (average particle | | | | | |
| | diameter: 8 μm, milled) | | | | | |

Measurement results

| | | | | | |
|---|---|---|---|---|---|
| Thickness (mm) | 1 | 1 | 1 | 1 | 1 |
| Heat conductivity (W/m · K) | 2.9 | 3.4 | 2.3 | 2.5 | 2.0 |
| Asker C hardness | 26 | 30 | 14 | 28 | 22 |
| Flame retardancy (UL-94) | V-0 | V-0 | V-0 | V-0 | V-0 |
| Odor | A | A | A | A | A |
| Filling ratio of aluminum hydroxide in sheet (% by volume) | 69.5 | 73.6 | 62.2 | 69 | 60.3 |

| | | | | | |
|---|---|---|---|---|---|
| Comparative | Comparative | Comparative | Comparative | Comparative | Comparative |
| Example 1 | Example 2 | Example 3 | Example 4 | Example 5 | Example 6 |

Components (number of carbon atoms of alkyl group) parts by mass

| | | | | | | | |
|---|---|---|---|---|---|---|---|
| Binder | 2-ethylhexyl acrylate (C8) | 100.00 | | | | | |
| composition | Lauryl acrylate (C12) | | | | | 80.00 | 80.00 |
| | Partial polymer of lauryl acrylate (12) | | | | | 20.00 | 20.00 |
| | Isostearyl acrylate (C18) | | 100.00 | 100.00 | 100.00 | | |
| | Stearyl acrylate | | | | | | |
| | 1,6-hexanediol diacrylate (crosslinking agent) | 0.14 | 0.20 | 0.16 | 0.20 | 0.24 | 0.24 |
| | Diisononyl adipate (plasticizer) | 60.00 | 60.00 | 60.00 | 60.00 | 60.00 | 60.00 |
| | Irgacure ™ 819 (photoinitiator) | 0.30 | 0.30 | 0.30 | 0.30 | 0.30 | 0.30 |
| | Titacoat ™ S-151 (titanate coupling agent) | 4.00 | 4.00 | 4.00 | 4.00 | 4.00 | 4.00 |
| Filler | Aluminum hydroxide A (average particle | | | | | | |
| | diameter: 1.3 μm, non-milled) | | | | | | |
| | Aluminum hydroxide A (average particle | | | | 650 | | |
| | diameter: 8 μm, non-milled) | | | | | | |
| | Aluminum hydroxide C (average particle | | | | 250 | | |
| | diameter: 50 μm, non-milled) | | | | | | |
| | Aluminum hydroxide D (average particle | 220 | 220 | 100 | | 220 | |
| | diameter: 2 μm, milled) | | | | | | |
| | Aluminum hydroxide E (average particle | 660 | 660 | 360 | | 380 | 600 |
| | diameter: 8 μm, milled) | | | | | | |

Measurement results

| | | | | | | |
|---|---|---|---|---|---|---|
| Thickness (mm) | 1 | — | 1 | — | 1 | 1 |
| Heat conductivity (W/m · K) | 2.5 | — | 1.7 | — | 2.0 | 1.9 |
| Asker C hardness | 48 | — | 28 | — | 32 | 34 |
| Flame retardancy (UL-94) | V-0 | — | >=V-1 | — | >=V-1 | >=V-1 |
| Odor | Control | — | A | — | A | A |
| Filling ratio of aluminum hydroxide in sheet (% by volume) | 69.4 | — | 56.5 | — | 60.3 | 60.3 |

1) Irgacure is a trademark of Ciba Japan Limited.
2) Titacoat is a trademark of NIPPON SODA CO., LTD.
3) In the measurement results, “A” in odor shows less odor than that of the control sample of Comparative Example 1.
4) In the measurement results, the filling ratio of aluminum hydroxide in a sheet was calculated by parts by weight of the component using a specific gravity of a binder composition (1.0 g/cm³) and aluminum hydroxide (2.4 g/cm³).
5) “V-0” denotes a sample of a grade V-0, and “>=V-1” denotes a sample of a grade V-1 or lower.

### Description of Compounds in Table

2-ethylhexyl acrylate (having am alkyl group of 8 carbon atoms) (name of manufacturer: NIPPON SHOKUBAI CO., LTD., model number: AEH)

Lauryl acrylate (having an alkyl group of 12 carbon atoms) (name of manufacturer: OSAKA ORGANIC CHEMICAL INDUSTRY LTD., model number: LA)

Isostearyl acrylate (having an alkyl group of 18 carbon atoms) (name of manufacturer: OSAKA ORGANIC CHEMICAL INDUSTRY LTD., model number: ISTA)

Stearyl acrylate (name of manufacturer: OSAKA ORGANIC CHEMICAL INDUSTRY LTD., model number: STA)

1.6-hexanediol diacrylate (name of manufacturer: OSAKA ORGANIC CHEMICAL INDUSTRY LTD., model number: V#230)

Diisononyl adipate (name of manufacturer: DAIHACHI CHEMICAL INDUSTRY CO., LTD. model number: DINA)

Irgacure™ 819 (name of manufacturer: Ciba Japan Limited)

Titacoat™ S-151 (titanate coupling agent) (name of manufacturer: NIPPON SODA CO., LTD.)

Partial polymer of lauryl acrylate (having an alkyl group of 12 carbon atoms): obtained by mixing 100 parts by mass of lauryl acrylate with 0.04 parts by mass of Irgacure™ 651 (name of manufacturer: Ciba Japan Limited) in a glass container and irradiating the mixture under a nitrogen atmosphere using a constant-pressure mercury lamp at an irradiation intensity of 3 mW/cm² for several tens of seconds, thereby partially polymerizing the mixture. The partial polymer has a viscosity of 2,000 mPa·s.

Aluminum hydroxide A (average particle diameter 1.3 μm, obtained by a precipitation method and is non-milled) (name of manufacturer: Nippon Light Metal Co., Ltd. (the same shall apply to E), model number: BF013)

Aluminum hydroxide B (average particle diameter 8 μm, obtained by a precipitation method and is non-milled) (model number: BF083)

Aluminum hydroxide C (average particle diameter 50 μm, obtained by a precipitation method and is non-milled) (model number: B53)

Aluminum hydroxide D (average particle diameter 2 μm, milled) (model number: B1403)

Aluminum hydroxide E (average particle diameter 8 μm, milled) (model number: B103)

### Comparative Examples 1, 3, 5, 6

In the same manner as in Example 1, except for a different formulation, acrylic thermal conductive sheets were produced.

### Comparative Examples 2, 4

In the same manner as in Example 1, except for a different formulation, attempts to producing acrylic thermal conductive sheet were made. However, the mixtures had high viscosity and poor fluidity and therefore sheets could not be produced.

Thermal conductivity, hardness, flame retardancy and odor of these thermal conductive sheets were evaluated by the above methods. The results are shown in Table 2.

For reference, each viscosity at 20° C. of various acrylates is described.

TABLE 2

| Name of substance | |
|---|---|
| (Number of carbon atoms of alkyl group) | Viscosity (mPa · s) |
| Ethyl acrylate (2) | 0.6 |
| n-butyl acrylate (3) | 0.9 |
| 2-ethylhexyl acrylate (8) | 1.7 |
| Lauryl acrylate (12) | 4.0 |
| Isostearyl acrylate (18) | 18 |

As described above, since a (meth)acrylate monomer having an alkyl group of 12 to 18 carbon atoms has high viscosity, deterioration of processability is caused by thickening when compared with a (meth)acrylate monomer having an alkyl group of 2 to 8 carbon atoms which has originally low viscosity.

### Results

Even when aluminum oxide particles are added to a binder component (A) containing an alkyl(meth)acrylate monomer having an alkyl group of 12 to 18 carbon atoms and/or a partial polymer thereof in the amount of more than 60% by volume based on the entire hardened material, a mixture having satisfactory workability could be obtained.

It was possible to obtain a high thermal conductive sheet of about 2.0 to 3.4 (W/m·K), which has low or no odor and high flame retardancy corresponding to a level V-0 in UL-94, and also has a high filling ratio of aluminum hydroxide particles increased to from about 60 to about 74%, by including both the acrylate composition having an alkyl group of the above-mentioned carbon atoms and the above-mentioned metal hydroxide. It was also found that the resulting sheets are excellent in flexibility (hardness of 28 in Example 4) to the thermal conductive sheet using milled aluminum hydroxide particles (hardness 48 in Comparative Example 1) when compared with the thermal conductive sheet having the same volume filling ratio 69%.

1. An acrylic thermal conductive sheet made of hardened material comprising:
a binder component (A) containing at least one alkyl(meth)acrylate monomer having an alkyl group of 12 to 18 carbon atoms and/or a partial polymer thereof;
aluminum hydroxide particles (B) having an average particle diameter of 0.3 μm or more and less than 4.0 μm which are obtained by a crystallization method and are not subjected to a pulverization treatment;
aluminum hydroxide particles (C) having an average particle diameter of 4.0 μm or more and 15.0 μm or less which are obtained by a crystallization method and are not subjected to a pulverization treatment, and also satisfy the relation: average particle diameter of the particles (C)/average particle diameter of the particles (B)=3 to 15; and
a reaction initiator (D); wherein
the content of the component (A) is 100 parts by mass, the content of the component (B) is from 50 to 400 parts by mass, the content of the component (C) is from 50 to 1,000 parts by mass, and the content of the component (D) is from 0.01 to 5 parts by mass.

2. The acrylic thermal conductive sheet according to claim 1, being made of hardened material further comprising aluminum hydroxide particles (E) having an average particle diameter of 40 to 90 μm which are obtained by a crystallization method and are not subjected to a pulverization treatment, wherein the content of the component (A) is 100 parts by mass, the content of the component (B) is from 50 to 400 parts by mass, the content of the component (C) is from 50 to 1,000 parts by mass, the content of the component (D) is from 0.01 to 5 parts by mass, and the content of the component (E) is from 0.01 to 700 parts by mass.

3. The acrylic thermal conductive sheet according to claim 2, wherein the total filling ratio of the component (B), the component (C) and the component (E) is from 60 to 80% by volume of the acrylic thermal conductive sheet based on the entire hardened material.

4. A method for producing an acrylic thermal conductive sheet, which comprises the steps of:
mixing a binder component (A) containing at least one alkyl(meth)acrylate monomer having an alkyl group of 12 to 18 carbon atoms and/or a partial polymer thereof,
aluminum hydroxide particles (B) having an average particle diameter of 0.3 μm or more and less than 4.0 μm which are obtained by a crystallization method and are not subjected to a pulverization treatment,
aluminum hydroxide particles (C) having an average particle diameter of 4.0 μm or more and 15.0 μm or less which are obtained by a crystallization method and are not subjected to a pulverization treatment, and also satisfy the relation: average particle diameter of the particles (C)/average particle diameter of the particles (B)=3 to 15, and
a reaction initiator (D)
in a ratio of 100 parts by mass of the component (A); 50 to 400 parts by mass of the component (B); 50 to 1,000 parts by mass of the component (C); 0.01 to 5 parts by mass of the component (D); and
forming the mixture obtained by the above mixing step into a sheet and hardening the sheet.
